(19) United States
(12) Patent Application Publication
(10) Pub. No.: US 2009/0195876 A1
(43) Pub. Date: Aug. 6, 2009

(54) METHOD FOR DESCRIBING A RETARDATION DISTRIBUTION IN A MICROLITHOGRAPHIC PROJECTION EXPOSURE APPARATUS

(75) Inventor: Daniel Kraehmer, Essingen (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 12/421,858

(22) Filed: Apr. 10, 2009

Related U.S. Application Data
(62) Division of application No. 11/312,147, filed on Dec. 20, 2005.
(60) Provisional application No. 60/641,422, filed on Jan. 5, 2005.

(51) Int. Cl. G02B 27/28

(52) U.S. Cl. 359/499

(57) ABSTRACT

In a method for describing a retardation distribution of a light bundle emerging from a selected field point, which passes through a birefringent optical element contained in an optical system of a microlithographic projection exposure apparatus, a distribution of retardation vectors is determined so that precisely one direction of a retardation vector is allocated to each directionless orientation of the retardation. The retardation vector distribution is then at least approximately described as a linear superposition of predetermined vector modes with scalar superposition coefficients.

### CROSS-REFERENCE TO RELATED APPLICATIONS

This application claims benefit of provisional application Ser. No. 60/641,422 filed Jan. 5, 2005. The full disclosure of this earlier application is incorporated herein by reference.

### BACKGROUND OF THE INVENTION

1. Field of the Invention

The invention relates to microlithographic projection exposure apparatus such as those used for the production of large-scale integrated electrical circuits and other microstructured components. The invention relates in particular to a method by which a retardation distribution in an exit pupil can be described for individual birefringent optical elements or optical systems formed by them in such an arrangement.

2. Description of the Related Art

Integrated electrical circuits and other microstructured components are conventionally produced by applying a plurality of structured layers to a suitable substrate which, for example, may be a silicon wafer. In order to structure the layers, they are first covered with a photoresist which is sensitive to light of a particular wavelength range, for example light in the deep ultraviolet (DUV) spectral range. The wafer coated in this way is subsequently exposed in a projection exposure apparatus. A pattern of diffracting structures, which is arranged on a reticle, is then imaged onto the photoresist with the aid of a projection objective. Since the imaging scale is generally less than one, such projection objectives are also often referred to as reduction objectives.

After the photoresist has been developed, the wafer is subjected to an etching process so that the layer becomes structured according to the pattern on the reticle. The remaining photoresist is then removed from the other parts of the layer. This process is repeated until all the layers have been applied to the wafer.

One of the essential aims in the development of microlithographic projection exposure apparatus is to be able to generate structures with smaller and smaller dimensions on the wafer, so as to increase the integration density of the components to be produced. By using a wide variety of measures, it is now possible to generate structures on the wafer whose dimensions are less than the wavelength of the projection light being used.

Particular importance is in this case attached to the polarization state of the projection light arriving on the photoresist. This is because the polarization state has a direct effect on the contrast which can be achieved, and therefore the minimum size of the structures to be generated. The polarization dependency of the contrast becomes particularly significant particularly in projection objectives with high numerical apertures, for example those which are possible in immersion objectives.

For this reason, attempts are made to configure the most important optical subsystems of the projection exposure apparatus, i.e. the illumination system and the projection objective, so that they do not undesirably change a polarization state once it has been set.

The cause of undesirable changes in the polarization state is often the birefringence of materials which are used for producing the lenses and other optical elements. The term optically birefringent refers to transparent materials whose refractive index is anisotropic. This means that the refractive index for a transmitted light ray depends on its direction and its polarization state. When it passes through a birefringent material, therefore, unpolarized light will generally become split into two rays with mutually orthogonal polarizations, i.e. the ordinary ray and the extraordinary ray. The term “the birefringence” in the strict sense refers to the maximum difference Δn=nₑₒ−nₒ occurring between the refractive indices, where nₑₒ is the refractive index for the extraordinary ray and nₒ is the refractive index for the ordinary ray. The birefringence Δn is often specified with the units [nm/cm].

The birefringence of optical materials can be caused by different factors. In general, crystals with a non-cubic crystal structure are relatively highly birefringent. Within particular wavelength ranges, however, cubic crystals such as calcium fluoride (CaF₂) may also be optically birefringent. Such materials are referred to as intrinsically birefringent.

Perturbations of the short-range atomic order due to material stresses are another cause of birefringence, and this can also occur in non-crystalline materials. Such a material is generally referred to as stress-induced birefringent. The material stresses may, for example, be caused by externally acting mechanical forces. Often, the material loses its birefringent property again when the causes of the short-range order perturbations cease. For example, if a lens mounting exerts mechanical forces on a lens body held in it, where these forces lead to stress-induced birefringence, then this birefringence is in general fully or at least predominantly eliminated as soon as the lens mounting is removed again.

If the stresses due to external forces remain in the material, then this can lead to an irreversible stress-induced birefringence. This effect is observed in quartz glass preforms, which are used for the production of lenses and other refractively acting optical elements. The stress-induced birefringence often encountered in them is generally production-related; in these cases, the magnitude and orientation of the birefringence often have an at least approximately rotationally symmetrical profile with respect to a symmetry axis of the preform, at least when certain production methods are used. The magnitude of the birefringence then in general increases approximately quadratically as the distance from the optical axis of the preform increases.

In order to avoid perturbations due to stress-induced birefringence in the illumination system or the projection objective of a microlithographic projection exposure apparatus, preforms whose irreversible stress-induced birefringence is as small as possible are used. Such preforms, however, are generally much more expensive and may not always be readily available.

U.S. Pat. No. 6,583,931 B2 discloses a method in which the stress-induced birefringence of synthetic quartz glass lens preforms is measured. The measurement points in this case lie on circles which extend concentrically with the symmetry axis of the preform, and therefore with the symmetry axis of the lens subsequently manufactured from the preform. If the fast birefringent axis extends in a radial direction, then the measurement value is regarded as positive. For fast birefringent axes extending tangentially, the measurement value is given a minus sign. It is thereby possible to discriminate between radial and tangential birefringence distributions.

An average value with a positive or negative sign is also formed from the measurement values of all the measurement points which lie on a circle. Multiplying by the thickness value allocated to the lens in question leads to a kind of retardation. After dividing by the sum of the individual thicknesses and by the number of circles on which measurement points are recorded, a positively or negatively signed value which characterizes the birefringence properties is obtained for the optical system overall.

It has been found, however, that the average values provided by the aforementioned known method offer only a very inaccurate description of the birefringence due to individual lenses, or to optical systems formed by them. In particular, this also applies to the physical quantity which is crucial in respect of imaging properties, i.e. the retardation.

### SUMMARY OF THE INVENTION

For optimum configuration and optical polarization correction of the optical system of a projection exposure apparatus, it is expedient that the retardation caused by birefringence should be described and evaluated in the physically most informative and precise manner.

It is therefore an object of the invention to provide a method for describing retardation distributions of an optical system of a microlithographic projection exposure apparatus, and in particular an illumination system or a projection objective, as well as the optical elements contained in it. It is a particular object of the present invention to provide such a method by which the retardation can be described and evaluated in the physically most informative and precise manner.

It is a further object of the invention to provide a method for producing an optical system of a microlithographic projection exposure apparatus, in which imaging errors attributable to retardations caused by birefringence are reduced.

The first object is achieved by a method for describing a retardation distribution in an exit pupil for a light bundle emerging from a selected field point, which indicates the magnitude and directionless orientation of a retardation experienced by components polarized parallel to the orientation in a light bundle emerging from the selected field point, relative to components polarized perpendicularly to it, when the light bundle passes through a selected birefringent optical element which is contained in an optical system of a microlithographic projection exposure apparatus, the method having the following steps:
a) determining a distribution of retardation vectors so that precisely one direction of a retardation vector is allocated to each directionless orientation of the retardation;
b) at least approximately describing the retardation vector distribution obtained in step a) as a linear superposition of predetermined vector modes with scalar superposition coefficients.

The allocation of the retardation, which per se involves only an orientation but not a direction, to retardation vectors makes it possible to describe and optionally evaluate the sometimes very complex retardation distribution over the exit pupil in a straightforward and—with a suitable choice of the vector modes—also physically informative way. With the aid of the superposition coefficients it is possible to compare the retardation due to birefringence in a straightforward way, not only between individual optical elements but also between different projection objectives or illumination systems. Retardation distributions can also be classified and evaluated with the aid of the superposition coefficients, as is similarly the case when describing wavefronts with the aid of known function systems, for example the Zernike polynomials.

With suitably chosen vector modes, it is furthermore possible to separate rotationally symmetrical and azimuthally varying components of the retardation distribution from one another. This is expedient in so far as rotationally symmetrical retardation distributions are generally less critical and easier to correct than azimuthally varying retardation distributions.

One way of allocating a retardation to a retardation vector is to use a transformation, in which an angle θ between the orientation of the retardation and a reference direction is converted into an angle θ′=2θ between the direction of the allocated retardation vector and the reference direction.

For stress-induced birefringence distributions which have a quadratic rotationally symmetrical profile, it has been found that with a suitable choice of the vector modes the retardation distributions in the exit pupil can be characterized very accurately by merely three scalar superposition coefficients. A first scalar superposition coefficient is in this case a measure of a spatially constant part of the retardation distribution, a second scalar superposition coefficient is a measure of a tilt of the retardation distribution and a third scalar superposition coefficient is a measure of a rotationally symmetrical quadratic part of the retardation distribution.

The inventive description of the retardation distribution also makes it possible to carry out various measures for the initial configuration of the optical system, by which the optical polarization properties can be improved.

The method according to the invention is particularly suitable for describing retardation distributions which are caused by stress-induced birefringent optical elements, and especially those with rotationally symmetrical birefringence distributions. Nevertheless, it can very simply but accurately describe those retardation distributions which are caused by intrinsically birefringent materials, for example calcium fluoride (CaF₂) or similar fluoride crystals.

The vector modes used to describe the retardation distribution should represent a complete and orthogonal function system. A complete function system allows an arbitrary retardation distribution to be approximated with any desired accuracy by a linear superposition. An orthogonal function system ensures that the chosen decomposition into vector modes is unique.

In particular cases, however, it may be more favorable to use a system of vector modes which is not complete and/or not orthogonal for describing the retardation distributions. This is expedient, for example, when the vector modes of such a function system are physically particularly informative, or if a large proportion of the retardation distributions can be described by particularly few non-zero superposition coefficients. The components of the vector modes may contain polynomials which themselves represent a complete orthogonal function system.

In order to determine the birefringence distribution of an optical element, the birefringence distribution which indicates the magnitude of the birefringence and the orientation of a birefringent axis (fast or slow axis) may be determined first. This birefringence distribution is then transformed into a distribution of birefringence vectors, specifically so that precisely one direction of a birefringence vector is allocated to each directionless orientation of the birefringence. This distribution of birefringence vectors is then multiplied by a thickness profile of the optical element. The distribution of the retardation vectors is then obtained directly. Whereas the thickness profile relates to the shape of the optical element as it will be finally installed in the optical system, the birefringence vector distribution can be determined independently of shape for a preform from which the optical element is to be produced. The same principles as those explained in connection with the transformation of retardation distributions into retardation vector distributions also apply to the transformation of the birefringence distribution into a birefringence vector distribution.

If the material in question is intrinsically birefringent, then it is often possible to derive the birefringence distribution from previous measurements if the orientation of the crystal lattice is known. For stress-induced birefringent materials, however, the birefringence distribution generally depends on unknown production parameters, so that measurement of the birefringence distribution offers the most accurate results.

In order to simplify the multiplication of the birefringence vector distribution by the thickness profile of the optical element, the birefringence vector distribution may first be described as a linear superposition of the vector modes with scalar second superposition coefficients. If the thickness profile, described for example as a function of a height of a point on the optical element from the symmetry axis, is subsequently described as a linear superposition of functions with scalar third superposition coefficients, then the multiplication leads to a series of terms only a few of which are in general significantly non-zero. These terms can then be described as a superposition of the vector modes with the aid of the superposition coefficients.

The expansion into the system of vector modes is particularly straightforward when the functions used to describe the thickness profile are components of the vector modes. The mixed terms resulting from the multiplication can then be allocated in a straightforward way to individual vector modes.

If the retardation distribution in the exit pupil is determined for a few field points, for example a field point at the field centre, field points at the field edges and for at least one field point lying between them, then quite an accurate image of the optical polarization effects due to a birefringent optical element can already be obtained. This procedure furthermore has the advantage that the retardation distribution of the light bundle emerging from the relevant field point, after a plurality of optical elements, can be described in a very straightforward way by the sum of the superposition coefficients allocated to the individual optical elements.

Specifying retardation distributions for light bundles which emerge from selected field points also has the advantage that the retardation distribution, which is caused by an optical system having a plurality of birefringent optical elements, can be characterized in a very straightforward but accurate way by quality indices which incorporate the superposition coefficients associated with a vector mode for the individual optical elements. In the simplest case, such a quality index may be defined as being the sum of the superposition coefficients associated with a vector mode.

If a plurality of quality indices, for example three quality indices, are assigned to a selected field point for each optical element or at least each stress-birefringent optical element, then a total quality index of the optical system for a vector mode can be determined by averaging from the quality indices of the relevant vector mode as determined for the selected field points.

The quality indices may be used when producing the optical system in order to ascertain specifications for birefringence distributions of the birefringent optical elements contained in it, so that at least one quality index is improved and in particular lies within a predetermined limit value range. In the scope of such a method, the thickness profiles of the optical elements are first determined with the aid of design programs which are known per se. Quality indices are then determined in the manner described above, with birefringence distributions firstly being assumed for the optical elements. If it is found that at least one quality index is outside a predetermined limit value range, then the design is changed.

This modification may in particular involve departing from the birefringence distribution originally assumed for at least one optical element. The modified birefringence distribution may, for example, be such that it is at least approximately orthogonal to the birefringence distribution provided in the original design. In this way, at least partial compensation is achieved for a retardation due to other optical elements.

As an alternative or in addition to this, the magnitudes of the modified birefringence may at least on average be less than the magnitudes of the birefringence distribution provided in the original design.

### BRIEF DESCRIPTION OF THE DRAWINGS

Other features and advantages will be found in the following description of an exemplary embodiment with reference to the drawing, in which:

FIG. 1 shows a projection exposure apparatus in a simplified meridian section which is not true to scale;

FIG. 2 shows a birefringence distribution of a stress-induced birefringent lens preform;

FIG. 3a shows four retardations of equal magnitude but with different orientations;

FIG. 3b shows retardation vectors which are derived by transformation from the retardations shown in FIG. 3a;

FIG. 4 shows a flow chart of a method according to the invention for describing a retardation distribution;

FIGS. 5a to 5d show graphical representations of vector modes for orders 1 to 4;

FIGS. 6a to 6d show graphical representations of vector modes for orders −1 to −4;

FIGS. 7a to 7h show graphical representations of retardation distributions which are obtained from the vector Zernike modes for orders 1 to 4, 6, 8, 10 and 13;

FIG. 8 shows a flow chart of a method according to the invention for determining a retardation distribution due to a birefringent optical element;

FIG. 9 shows a bar chart which represents the superposition coefficients for a retardation distribution;

FIG. 10 shows a graph to explain geometrical quantities of a region illuminated by a light bundle emerging from a field point;

FIGS. 11 to 13 show bar charts which respectively indicate a superposition coefficient for all the lenses of a hypothetical projection objective;

FIG. 14 shows a flow chart of a method according to the invention for reducing retardations in an optical system of a microlithographic projection exposure apparatus.

### DESCRIPTION OF PREFERRED EMBODIMENTS

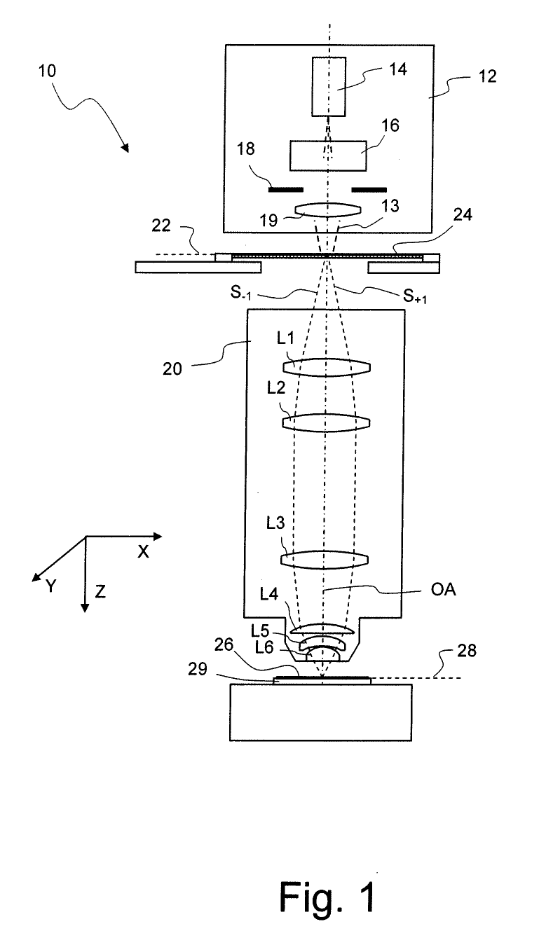

FIG. 1 shows a meridian section through a microlithographic projection exposure apparatus, denoted overall by 10, in a highly schematic representation which is not true to scale. The projection exposure apparatus 10 has an illumination system 12 for producing a projection light beam 13, which comprises a light source 14. The light source 14, which may for example be an excimer laser, produces short-wave projection light. In the present exemplary embodiment, the wavelength of the projection light is 193 nm. It is likewise possible to use other wavelengths, for example 157 nm or 248 nm.

The illumination system 12 furthermore contains illumination optics indicated by 16, and a diaphragm 18. The illumination optics 16 suitably reshape the projection light beam produced by the light source 14 and make it possible to set different illumination angle distributions. To this end, for example, the illumination device may contain interchangeable diffractive optical elements or microlens arrays. Since such illumination optics are known in the prior art, see for example U.S. Pat. No. 6,285,443 A, the content of which is fully incorporated into the subject-matter of the present application, further details of these need not be explained here. An objective 19 projects a sharp image of the diaphragm 18 on a downstream object plane of a projection objective 20.

The projection objective 20 contains a multiplicity of lenses, only some of which denoted by L1 to L6 are represented by way of example in FIG. 1 for the sake of clarity. The projection objective 20 is used to project a reduced image of a reticle 24, which can be arranged in an object plane 22 of the projection objective 20 and is illuminated by the projection light beam 13, onto a photosensitive layer 26 which may be a photoresist, for example. The layer 26 is located in an image plane 28 of the projection objective 20 and is applied to a support 29, for example a silicon wafer.

In the exemplary embodiment represented, the lenses L1 to L5 are respectively made from lens preforms which consist of synthetic quartz glass and are conventionally in the form of circular discs. Material stresses, which lead to a stress-induced birefringence, are often created in the quartz glass during production of the lens preforms. The birefringence is generally not then spatially constant, but its direction and magnitude vary over the end face of the lens preforms. In the direction of the symmetry axis extending through the middle of the lens preforms, however, the birefringence is constant at least to a first approximation. Measurements furthermore show that the stress-induced birefringence depends only weakly on the direction at which a light ray strikes the end face of a lens preform.

The magnitude and direction distributions of the birefringence over the end face of the lens preform is determined primarily by the method used for producing the lens preform. If rotationally symmetrical conditions prevail during production, then the spatial birefringence distribution will in general also be at least approximately rotationally symmetrical, the magnitude of the birefringence increasing as the distance from the symmetry axis increases. This increase is usually quadratic, with the slow axis of the birefringence extending either radially or tangentially.

FIG. 2 shows a local birefringence distribution of a lens preform, as determined by measurement. The length of the lines which can be seen in FIG. 2 is proportional to the magnitude of the stress-induced birefringence, whereas the orientation of the lines indicates the orientation of the fast axis of the birefringence. In this lens preform, the birefringence is also rotationally symmetrical and increases quadratically as the distance from the symmetry axis increases. If points P on the end face of the lens preform are indicated by polar coordinates (r,φ), then the magnitude of the birefringence is virtually independent of the azimutal angle coordinate φ and at least approximately increases quadratically with the radial coordinate r.

The lens L6 is made of a cubic crystalline material, for example calcium fluoride (CaF₂) or barium fluoride (BaF₂), which is highly transparent but intrinsically birefringent even at very short projection light wavelengths, for example 193 nm or 157 nm.

Two diffraction orders S₋₁ and S₊₁, which are intended to constructively interfere in the image plane 28, are indicated by way of example in FIG. 1. If the polarization state of the diffraction orders S₋₁, and S₊₁ is perturbed in optical elements of the projection objective 20, then in general the two diffraction orders S₋₁ and S₊₁ will only be able to interfere incompletely in the image plane 28. This leads to an undesirable contrast loss. Polarization state perturbations may, for example, be caused by the lenses L1 to L6 when the lens material being used is intrinsically and/or stress-induced birefringent.

The crucial quantity in respect of the polarization state perturbation is the retardation experienced by a linear polarization component in a birefringent material, relative to a linear polarization component orthogonal to it. The term retardation is intended here to mean a quantity which has both a magnitude and a directionless orientation.

The magnitude of the retardation is equal to the magnitude of the birefringence multiplied by the geometrical path length which the two orthogonal polarization components travel in the material. Since the magnitude of the birefringence is dimensionless, the magnitude of the retardation (which is often also referred to as the “optical path difference”) is physically a length and is conventionally indicated with units of length [nm].

The orientation of the retardation coincides with the orientation of the birefringence. Here, the orientation of the birefringence refers to the position of the slow birefringent axis. This is given by the position of the longer major axis of an elliptical section, obtained by cutting the refractive index ellipsoid for the relevant ray with a plane perpendicular to the ray direction and passing through the middle of the refractive index ellipsoid. The magnitude of the birefringence then corresponds to the difference between the major axis lengths of the elliptical section. If the position of the fast birefringent axis is selected for the birefringence orientation, instead of the position of the slow birefringent axis, then the orientation obtained for the birefringence and accordingly for the retardation would be rotated through 90°.

The orientation of the retardation is important for determining whether the polarization state of a light ray changes as it passes through the birefringent material. If a light ray passing through a birefringent material is linearly polarized along the orientation of the retardation, i.e. parallel to the slow birefringent axis, or perpendicularly to it, then the polarization state does not change. With any other orientation of the polarization direction, the light ray becomes split into two ray components which are linearly polarized along the birefringent axes and propagate with different phase velocities in the material. If the geometrical path of the components in the material is longer, then the component with the lower phase velocity will experience a commensurately greater retardation relative to the component with the higher phase velocity.

The orientation of the retardation is a directionless quantity because the polarization direction is not actually a direction in the strict sense, but only a directionless orientation. Here, the term “orientation” is intended to mean the angular position of a straight line in space, whereas the term “direction” contains additional information about the viewing direction along this line. In connection with vectors, however, unlike other usage, the term “direction” refers to a directional orientation which is expressed by an arrowhead for the graphical representation of vectors.

Since the orientation of the retardation is a directionless quantity, physical effects are encountered only when this orientation varies within an angle range of 180° in the plane intersecting the middle of the elliptical section. A retardation orientation denoted by an angle θ with respect to a reference direction in this plane is therefore physically no different from an orientation denoted by an angle θ+180°.

In order to better describe the retardation mathematically as a quantity specified by magnitude and directionless orientation, a transformation is firstly carried out which uniquely allocates a vector distribution, that is to say a distribution of vectors having magnitudes and directional orientations, to the retardation distribution of directionless orientations in the pupil.

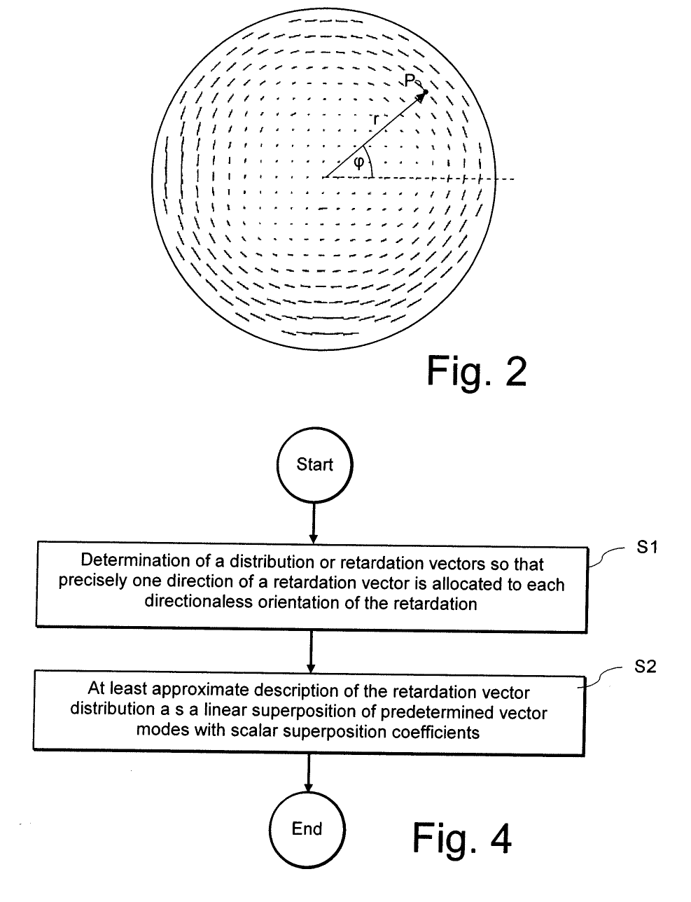

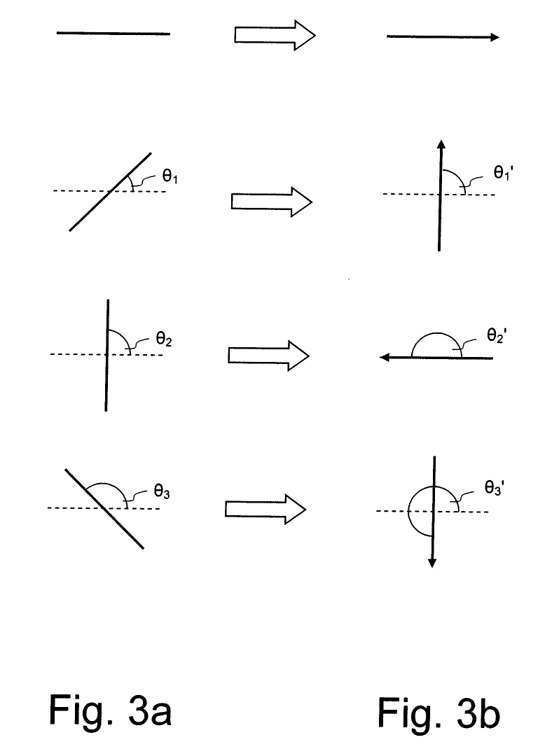

This will be demonstrated below with reference to FIGS. 3a and 3b, which show selected orientations of the retardation with respect to a reference direction (represented by dashes) and the directions as obtained by the trans-formation for a retardation vector R allocated to the respective orientation. As can be seen in FIGS. 3a and 3b, the angle θ between the orientation of the retardation and the reference direction is thereby converted into an angle θ′=2θ, where θ′ is the angle between the retardation vector R and the reference direction. The effect of this allocation is that precisely one direction of the retardation vectors is reversibly allocated uniquely to any possible orientation. Of course, other transformation equations may be envisaged in this context, for example θ′=2θ+α₀, where α₀ is an arbitrary angle.

The retardations experienced by rays emerging from a field point and passing through a birefringent material can be allocated most simply to the individual rays if the retardation is described in the exit pupil allocated to the field point. Taken together, the retardations for all the rays emerging from this field point then form the retardation distribution. The retardation vector R used here to describe the retardation is then a function of pupil coordinates (p,q), i.e. R=R(p,q).

Two steps are required in order to be able to characterize the retardation distribution of one of the lenses L1 to L6 of the projection objective 20 in a physically informative way, as demonstrated in the flow chart shown in FIG. 4. In a first step S1, a distribution of retardation vectors is determined so that precisely one direction of a retardation vector is allocated to each directionless orientation of the retardation. In a second step S2, the retardation vector distribution obtained in this way is approximately described as a linear superposition of predetermined vector modes with scalar superposition coefficients.

Since only a small number of superposition coefficients will normally be significantly non-zero, it is generally sufficient to specify a few superposition coefficients in order to characterise the retardation distribution. The superposition coefficients obtained in this way may then, for example, be compared with the superposition coefficients of other lenses. In many cases, furthermore, the retardation distribution due to the entire projection objective 20 can be characterized for individual field points by simple addition of the superposition coefficients, as will be explained in more detail below with reference to a specific exemplary embodiment.

A method for decomposing distributions of retardation vectors into vector modes, so that they can be described in a physically informative way by few parameters, will firstly be indicated below very generally. Methods by which the retardation vector distribution can be determined directly from a birefringence distribution of a lens preform will then be explained.

Decomposition of the Retardation Vector Distribution into Vector Modes

For a point P specified by pupil coordinates (p,q), the retardation vector R(p,q) can be decomposed by series expansion into vector modes Vᵢ(p,q) according to the equation

$$R ( p , q ) \approx {\sum }_{i} {v}_{i} {V}_{i} ( p , q ) . \qquad ( 1 )$$

Here, vᵢ denote scalar superposition coefficients.

The system of vector modes Vᵢ(p,q) should be complete in the mathematical sense. Only then is it possible to describe any retardation distributions R(p,q). The system of vector modes Vᵢ(p,q) should furthermore be orthogonal, since otherwise the decomposition of the retardation vectors will not be unique. In particular cases, however, it may be favorable for the description to use vector modes Vᵢ(p,q) which are not complete and/or orthogonal. It is expedient to use such vector modes, for example, when the superposition coefficients vᵢ can be numerically determined more easily, the vector modes are physically more informative or fewer superposition coefficients vᵢ are needed overall in order to characterize the optical polarization properties.

Two possible systems of vector modes Vᵢ(p,q), which are particularly suitable for the decomposition of a retardation vector distribution according to Equation (1), will be described below.

### Zernike Modes

If vector modes which have non-zero components in only one dimension are selected, then this leads to a decomposition of the distribution R(p,q) according to

$$\begin{matrix}R ( p , q ) = ( \begin{matrix}{R}_{x} ( p , q ) \\ {R}_{y} ( p , q )\end{matrix} ) \approx {\sum }_{j = 1}^{N} [ {v}_{jx} {V}_{jx} + {v}_{jy} {V}_{jy} ] & ( 2 ) \\ with & \\ {V}_{jx} = ( \begin{matrix}{U}_{j} ( p , q ) \\ 0\end{matrix} ) and {V}_{jy} = ( \begin{matrix}0 \\ {U}_{j} ( p , q )\end{matrix} ) . & ( 3 )\end{matrix}$$

If the Zernike polynomials often used for the description of wavefronts are selected for the components Uⱼ, according to

Uⱼ(p,q)=Rₙ^{m}(r)Φ(lθ) with j=(n,m,l), (4)

then the vector modes Vⱼₓ and V_{jy} referred to below as Zernike modes form an orthogonal function system. The orthogonality of two vector modes Vⱼₓ and Vⱼₓ for the same direction x or y follows from the orthogonality of the Zernike polynomials Uⱼ, Uₖ. Vector modes Vⱼₓ and V_{jy} in different dimensions are orthogonal owing to Equation (3). The completeness of the function system follows from the completeness of the Zernike polynomials Uⱼ.

If the vector modes V_{jy} are denoted by negative orders −j, then Equations (2) and (3) can be written as

$$\begin{matrix}R ( p , q ) \approx {\sum }_{j = - N}^{N} {v}_{j} {V}_{j} ( p , q ) & ( 5 ) \\ with & \\ {V}_{+ j} = ( \begin{matrix}{U}_{j} ( p , q ) \\ 0\end{matrix} ) , {V}_{- j} = ( \begin{matrix}0 \\ {U}_{j} ( p , q )\end{matrix} ) . & ( 6 )\end{matrix}$$

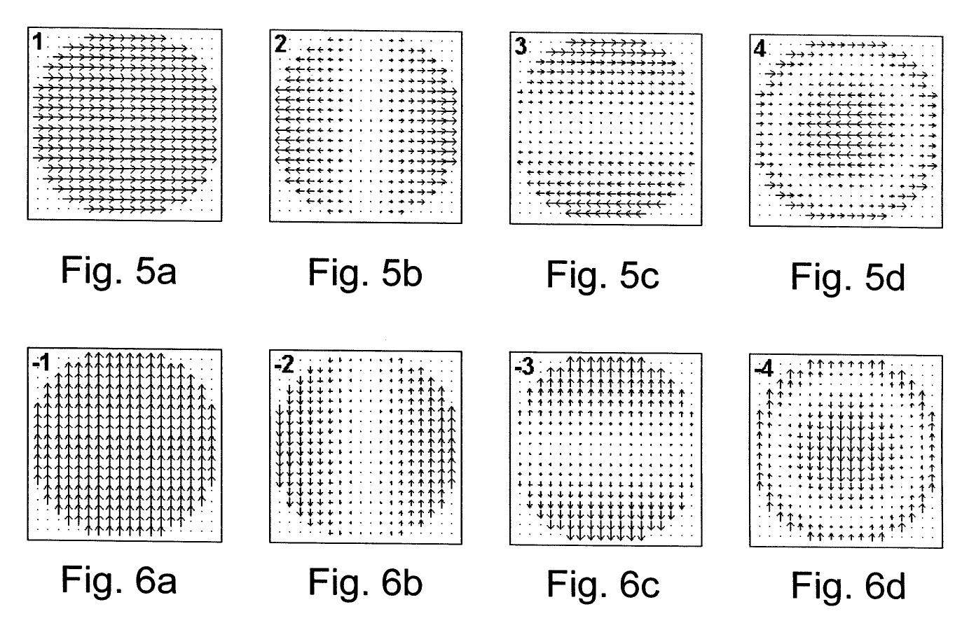

Graphical representations of the vector modes Vⱼ for the orders j=1 to 4 and j=−1 to −4 can be found in FIGS. 5a to 5d and 6a to 6d, respectively. The order j is respectively indicated at the top left.

The distributions of the magnitude and orientation of the vector modes are respectively similar to the known scalar distribution of the Zernike polynomials, by which phases of electromagnetic waves can be described. The two Zernike modes with the orders j=1 and j=−1 in this case represent a DC part which is constant over the entire exit pupil.

### Vector Zernike Modes

Another possible function system for vector modes, which is particularly suitable for the decomposition of retardation distributions according to Equation (1), is given by

Vⱼ=W_{nmε}=Rₙ^{m}(r)Φ_{mε}(φ), ε=0, 1. (7)

These modes W_{nmε}, referred to below as vector Zernike modes, contain a radial part Rₙ^{m}(r) which is equal to the radial part of the known Zernike polynomials Uⱼ according to Equation (4). The part Φ_{mε}(φ) dependent on the azimuth angle φ is given by

$${Φ}_{m 0} = ( \begin{matrix}cos m ϕ \\ - sin m ϕ\end{matrix} ) , {Φ}_{- m 0} = ( \begin{matrix}cos m ϕ \\ sin m ϕ\end{matrix} ) , \\ {Φ}_{m 1} = ( \begin{matrix}sin m ϕ \\ cos m ϕ\end{matrix} ) , {Φ}_{- m 1} = ( \begin{matrix}- sin m ϕ \\ cos m ϕ\end{matrix} ) \qquad ( 8 )$$

or, written in a simplified form,

$${Φ}_{m ɛ} = ( \begin{matrix}cos ( ɛ π / 2 ) & - sin ( ɛ π / 2 ) \\ sin ( ɛπ / 2 ) & cos ( ɛ π / 2 )\end{matrix} ) ( \begin{matrix}cos m ϕ \\ - sin m ϕ\end{matrix} ) , ɛ = 0 , 1. \qquad ( 9 )$$

The vector Zernike modes W_{nmε} likewise form a complete orthogonal function system and are therefore suitable for describing retardation vectors in the exit pupil.

Table 1 below indicates the allocation to the indices n, m and ε for the orders j=±1 to j=±10. For the orders j=±1 and j=±4, m=0 so that these vector Zernike modes are independent of angle.

TABLE 1
Allocation of the orders j to the indices n, m
and ε of the vector Zernike modes

| | j | | | | | | | | | | | | | | | | | | | |
|---|---|---|---|---|---|---|---|---|---|---|---|---|---|---|---|---|---|---|---|---|
| | 1 | −1 | 2 | −2 | 3 | −3 | 4 | −4 | 5 | −5 | 6 | −6 | 7 | −7 | 8 | −8 | 9 | −9 | 10 | −10 |
| n | 0 | 0 | 1 | 1 | 1 | 1 | 2 | 2 | 2 | 2 | 2 | 2 | 3 | 3 | 3 | 3 | 3 | 3 | 3 | 3 |
| m | 0 | 0 | 1 | 1 | −1 | −1 | 0 | 0 | 2 | 2 | −2 | −2 | 1 | 1 | −1 | −1 | 3 | 3 | −3 | −3 |
| ε | 0 | 1 | 0 | 1 | 0 | 1 | 0 | 1 | 0 | 1 | 0 | 1 | 0 | 1 | 0 | 1 | 0 | 1 | 0 | 1 |

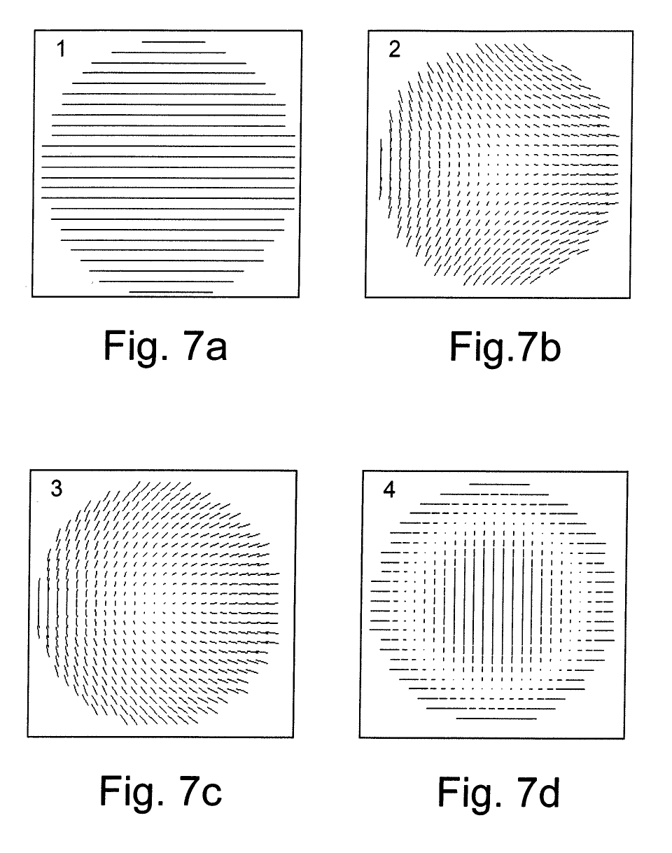

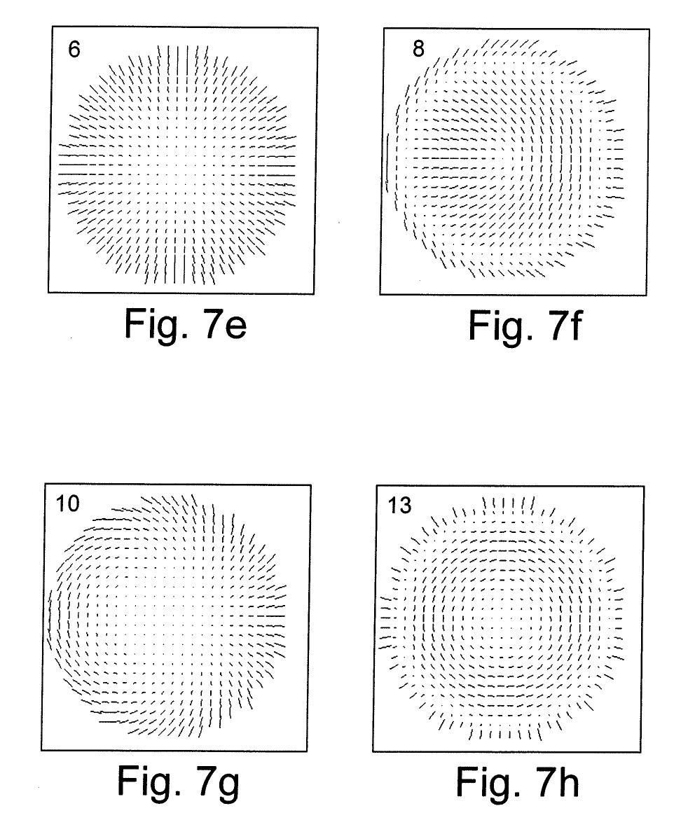

FIGS. 7a to 7h show graphical representations of the retardation distributions derived from the vector Zernike modes Wⱼ for the orders j=1, 2, 3, 4, 6, 8, 10 and 13. The retardation distributions are obtained from the vectors of the vector Zernike modes Wⱼ by inverse transformation according to θ=θ′/2, where θ again denotes the angle between the orientation of the retardation and the reference direction and denotes θ′ the angle between the direction of the allocated vector and the reference direction.

If the vector modes according to Equations (5) and (6) are likewise decomposed into a radial part and an angle-dependent part, then the following is obtained for the angle-dependent part Φ_{mε}

$${Φ}_{m 0} = ( \begin{matrix}cos m ϕ \\ 0\end{matrix} ) , {Φ}_{- m 0} = ( \begin{matrix}sin m ϕ \\ 0\end{matrix} ) , \\ {Φ}_{m 1} = ( \begin{matrix}0 \\ cos m ϕ\end{matrix} ) , {Φ}_{- m 1} = ( \begin{matrix}0 \\ sin m ϕ\end{matrix} ) . \qquad ( 10 )$$

### Determination of the Retardation Vector Distribution

In order to determine the retardation experienced by a polarization component of a light ray as it passes through a birefringent material, relative to a polarization component orthogonal to it, it is necessary to know the length of the geometrical path which the light ray travels in the material. For an exact calculation of the retardation, this path can be determined for each individual light ray with the aid of known ray-tracing programs.

For the projection objective of a projection exposure apparatus, it is usually of particular interest to know the retardation distribution which a light bundle emerging from an individual field point in the object plane of the projection objective has in the pupil plane. From the retardation distribution in the exit pupil, it is possible to deduce how the birefringence of the lenses through which the light bundle passes affects the contrast and other optical properties, for example telecentricity, of the projection objective. If the retardation distribution in the exit pupil is known for a few field points, then the optical polarization properties of the projection objective can be ascertained quite accurately.

In order to determine the retardation distribution in the exit pupil, the paths of orthogonal polarization components through the lenses may be reproduced by an exact calculation for a large number of light rays of a light bundle emerging from a field point, and the retardations respectively obtained by this may be determined, in which case the respective orientation of the birefringent axes should be taken into account. The retardations occurring in the individual lenses are then converted as described above into retardation vectors, which are finally superposed additively.

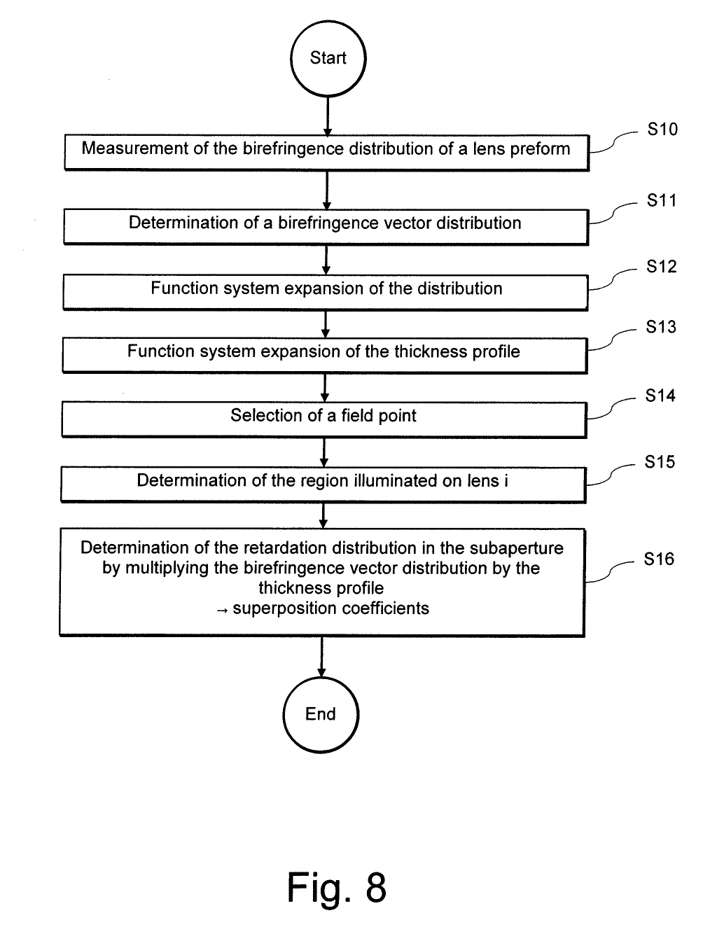

A simple approximation method will be indicated below, which allows straightforward and rapid determination of retardation vector distributions relating to individual field points and makes the decomposition into vector modes particularly easy. This approximation method is suitable in particular for determining the distribution of retardation vectors (or of a retardation distribution derived from them) in stress-induced birefringent lenses which have the typical rotationally symmetrical birefringence distribution increasing quadratically outwards. The approximation method will be explained below with reference to a flow chart shown in FIG. 8.

In a first step S10, the birefringence distribution of a lens preform intended for the production of a particular lens is measured. To this end, a linearly polarized light ray is transmitted through the generally disc-shaped lens preform at a multiplicity of points distributed over its entire surface. With the aid of optical polarization measuring devices which are known per se, the birefringence is determined as a function of the position of the respective measurement point. Details of possible measuring layouts can be found in U.S. Pat. No. 6,366,404 B1. The initial result of such a measurement is a spatial birefringence distribution, as shown by way of example in FIG. 2. The birefringence distribution indicates the magnitude and orientation of the birefringence over the surface of the lens preform.

In a second step S11, a distribution of birefringence vectors BR(r,φ) is determined from this birefringence distribution. The procedure adopted is the same as that described above with reference to FIGS. 3a and 3b for the transformation of a retardation distribution into a distribution of retardation vectors.

In a step S12, the birefringence vector distribution BR(r,φ) obtained in this way is decomposed according to

$$BR ( r , ϕ ) \approx {\sum }_{i} {BR}_{i} {V}_{i} ( r , ϕ ) \qquad ( 11 )$$

into vector modes Vᵢ(r,φ) with superposition coefficients BRᵢ. The vector Zernike modes defined above by Equation (7), in particular, are suitable as vector modes in this case.

The expansion of the birefringence BR(r,φ) into vector modes Vᵢ(r,φ) may, for example, be carried out by solving the linear equation system given below

$${\sum }_{j = 1}^{N} {A}_{ij} {x}_{j} = {b}_{i} , \\ with \\ i = 1 , … , M \qquad ( 12 )$$

with the quantities

$${A}_{ij} = ( \begin{matrix}{V}_{j}^{x} ( {r}_{i} , {ϕ}_{i} ) \\ {V}_{j}^{y} ( {r}_{i} , {ϕ}_{i} )\end{matrix} ) \\ {x}_{j} = {BR}_{j} \\ {B}_{i} = ( \begin{matrix}{BR}_{x} ( {r}_{i} , {ϕ}_{i} ) \\ {BR}_{y} ( {r}_{i} , {ϕ}_{i} )\end{matrix} ) \qquad ( 13 )$$

which may, for example, be solved by the method of least squares.

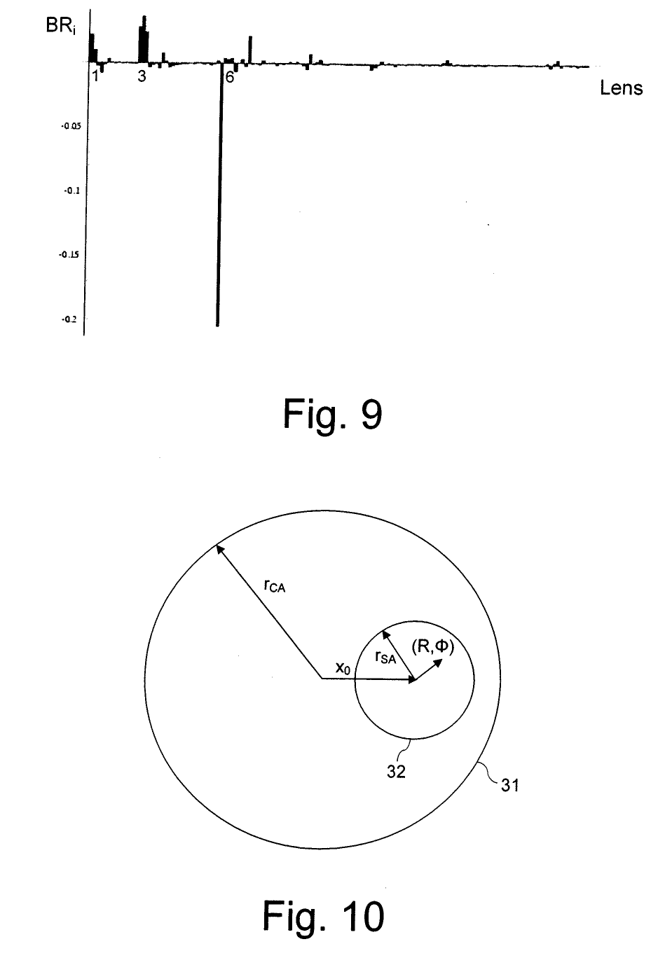

For the birefringence distribution shown in FIG. 2 with transversely extending birefringent axes, this gives superposition coefficients BRᵢ which are represented in the form of a bar chart in FIG. 9 for i=1 to i=140. It can be seen that the birefringence vector distribution is essentially dominated by the vector mode V₆. The birefringence distribution derived from this vector mode is graphically represented in FIG. 7e, and represents a rotationally symmetrical distribution in which the magnitude increases quadratically as the radial distance increases. The vector mode V₆ is given by

$${V}_{6} ( r , ϕ ) = {r}^{2} ( \begin{matrix}cos 2 ϕ \\ sin 2 ϕ\end{matrix} ) \qquad ( 14 )$$

Solving the equation system (12) leads to a superposition coefficient BR₆ which is given by

$${BR}_{6} = \frac{{\sum }_{k} {BR}_{k} \cdot {r}_{k}^{2} \cdot cos ( 2 {θ}_{k} - 2 {ϕ}_{k} )}{{\sum }_{k} {r}_{k}^{4}} \qquad ( 15 )$$

The index k=1, 2, . . . , M in this case counts the measurement points, of which there are M in all, where the birefringence on the preform is recorded.

In a further step S13, the thickness profile of the lens intended to be produced from the preform being measured is expanded into a function system. To this end, a function is used which describes the thickness of the lens as a function of the distance r from the symmetry axis. A lens with the central thickness d and the radii of curvature R⁽¹⁾ and R⁽²⁾ can then be specified approximately by a thickness function

$$d ( r ) \approx d + \frac{{r}^{2}}{2} ( \frac{1}{{R}^{( 2 )}} - \frac{1}{{R}^{( 1 )}} ) . \qquad ( 16 )$$

A radius of curvature R⁽¹⁾ is in this case regarded as positive if the centre of curvature lies in the positive direction, as viewed in the light propagation direction.

The thickness function d(r) is now decomposed according to the equation

$$d ( r ) \approx {\sum }_{i} {D}_{i} {U}_{i} ( r ) \qquad ( 17 )$$

into a function system. The Zernike polynomials Uᵢ(r) which depend only on the radial part are used as functions in Equation (17). Dᵢ denotes the superposition coefficients.

Another coordinate transformation may be carried out before the actual decomposition according to Equation (17), and this will be explained in more detail below with reference to FIG. 10. The purpose of the coordinate transformation is the intention to specify the retardation distribution for a light bundle which emerges from a particular field point selected in a step S14. The selected field point may, for example, be a salient field point, for instance a point in the middle of the field or at the edge of the field, or an arbitrary point.

The region on the lens which is illuminated by the light bundle is determined in a step S15. In FIG. 10, the useful free aperture of the lens is denoted by 31 and has a radius r_{CA}. Within the region 31, only a fairly small region 32 is illuminated by the light bundle emerging from the selected beam point, and this is often referred to as a subaperture. Only the region 32 of the lens is therefore important for the retardation distribution of the light bundle emerging from the selected field point. The circular region 32 is at a distance x₀ from the symmetry axis of the lens and has a radius r_{SA}; the primary beam associated with the selected field point passes through the middle of the region 32 (r_{SA}=0).

For simplicity, the aforementioned coordinate trans-formation introduces new coordinates (R,Φ) which are defined with respect to the centre of the region 32 and correspond to pupil coordinates. R and Φ are in this case defined by

$$R \cdot cos Φ = \frac{r \cdot cos ϕ - {x}_{0}}{{r}_{SA}}$$

$$and$$

$$R \cdot sin Φ = \frac{r \cdot sin ϕ}{{r}_{SA}} .$$

Owing to the coordinate transformation, with simultaneous expansion into Zernike functions, the equation

$$\begin{matrix}BR ( r ) = {BR}_{6} \cdot {V}_{6} ( r , ϕ ) \\ = {BR}_{6} \cdot {r}^{2} ( \begin{matrix}cos 2 ϕ \\ sin 2 ϕ\end{matrix} )\end{matrix} \qquad ( 18 )$$

becomes the equation

$$\begin{matrix}{BR}_{SA} ( R , Φ ) = ( \begin{matrix}{B}_{5} \cdot {Z}_{5} ( R , Φ ) + {B}_{2} \cdot {Z}_{2} ( R , Φ ) + {B}_{0} \\ {B}_{6} \cdot {Z}_{6} ( R , Φ ) + {B}_{3} \cdot {Z}_{3} ( R , Φ )\end{matrix} ) \\ with \\ {B}_{0} = {BR}_{6} \cdot {x}_{0}^{′2} \\ {B}_{2} = {B}_{3} = 2 {BR}_{6} \cdot {x}_{0}^{′} \\ {B}_{5} = {B}_{6} = BR \cdot {v}^{2} \\ and & ( 19 ) \\ v = \frac{{r}_{SA}}{{r}_{CA}} \\ {x}_{0}^{′} = \frac{{x}_{0}}{{r}_{CA}} & ( 20 )\end{matrix}$$

Taking the coordinate transformation into account, Equation (17) leads to

$${d}_{SA} ( R , Φ ) = {D}_{4} \cdot {Z}_{4} ( R ) + {D}_{2} \cdot {Z}_{2} ( R , Φ ) + {D}_{0} \\ with \\ {D}_{0} = d + α {dx}_{0}^{′} + \frac{1}{2} α {dv}^{2} \\ {D}_{2} = 2 α {dx}_{0}^{′} v \\ {D}_{4} = \frac{1}{2} α {dv}^{2} , \qquad ( 21 )$$

where α is given by

$$α = \frac{{r}_{CA}^{2}}{2 d} ( \frac{1}{{R}^{( 2 )}} - \frac{1}{{R}^{( 1 )}} ) \qquad ( 22 )$$

The index SA respectively characterizes the quantities relating to the region 32.

In a step S16, the retardation vector distribution R_{SA}(R,Φ) in the region 32 is determined for the field point selected in step S14 and the lens considered here, by multiplying the birefringence vector distribution BR_{SA} according to Equation (19) by the thickness profile d_{SA} within the region 32 according to Equation (21):

R_{SA}(R,Φ)=BR_{SA}(R,Φ)·d_{SA}(R,Φ) (23)

Multiplying out Equation (23) leads to a superposition of seven vector modes in all, according to

R(R,Φ)=v₁V₁+v₂V₂+v₃V₃+v₄V₄+v₆V₆+v₈V₈+v₁₀V₁₀+v₁₃V₁₃ (24)

The superposition coefficients v₁, v₂, v₃, v₄, v₆, v₈, v₁₀ and v₁₃ are in this case given by

$${v}_{1} = {BR}_{6} \cdot ( {dx}_{0}^{′2} + α {dx}_{0}^{′4} + α {dv}^{2} {x}_{0}^{′2} ) \\ {v}_{2} = {BR}_{6} \cdot α {dvx}_{0}^{′3} \\ {v}_{3} = {BR}_{6} \cdot ( 2 {dvx}_{0}^{′} + 3 α {dvx}_{0}^{′3} + 2 α {dv}^{3} {x}^{′} ) \\ {v}_{4} = {BR}_{6} \cdot \frac{3}{2} α {dv}^{2} {x}_{0}^{′2} \\ {v}_{6} = {BR}_{6} \cdot ( {dv}^{2} + \frac{3}{4} α {dv}^{4} + 3 α {dv}^{2} {x}_{0}^{′2} ) \\ {v}_{8} = {v}_{10} = {BR}_{6} \cdot α {dv}^{3} {x}_{0}^{′} \\ {v}_{13} = {BR}_{6} \cdot \frac{1}{4} α d {v}^{4} \qquad ( 25 )$$

However, only the vector modes V₁, V₃ and V₆ make significant contributions. Equation (24) can therefore be approximated by

$$\begin{matrix}R ( R , Φ ) \approx {v}_{1} {V}_{1} ( R , Φ ) + {v}_{3} {V}_{3} ( R , Φ ) + {v}_{6} {V}_{6} ( R , Φ ) \\ = {v}_{1} ( \begin{matrix}1 \\ 0\end{matrix} ) + {v}_{3} ( \begin{matrix}{Z}_{2} ( R , Φ ) \\ {Z}_{3} ( R , Φ )\end{matrix} ) + {v}_{6} ( \begin{matrix}{Z}_{5} ( R , Φ ) \\ {Z}_{6} ( R , Φ )\end{matrix} )\end{matrix} \qquad ( 26 )$$

The definition used here for the Zernike polynomials is:

Z₂(R,Φ)=R·cos Φ

Z₃(R,Φ)=R·sin Φ

Z₅(R,Φ)=R²·cos Φ)

Z₆(R,Φ)=R²·sin(2Φ)

The retardation distributions derived from the vector modes V₁, V₃ and V₆ are represented in FIGS. 6a, 6c and 6e respectively. It can be seen from the graphical representations that the vector mode V₁ describes a DC part of the retardation distribution, the vector mode V₃ describes a tilt of the retardation distribution and the vector mode V₆ describes a quadratic rotationally symmetrical part.

The retardation distribution obtained for the lens in question and for the field point selected in step S14 can therefore be characterized to a very good approximation by merely three values, that is to say by the superposition coefficients v₁, v₃ and v₆ Comparatively little data is required in order to be able to determine these values according to Equation (26). These data are, on the one hand, the quantities characterizing the thickness profile of the lens according to Equation (16). It is also necessary to determine the quantities x₀, r_{SA} and r_{CA}, which specify the size and position of the region 32 through which the light bundle passes. In order to determine these values, it is sufficient merely to determine the point of incidence on the lens for the primary ray and a peripheral ray of the light bundle. The superposition coefficients v₁, v₃ and v₆ are therefore relatively easy to determine. They furthermore provide a physically illustrative picture of the retardation distribution since, as explained above, the allocated vector modes describe a constant part, a tilt and a rotationally symmetrical part of the retardation distribution.

Since the retardation distribution, or respectively allocated the distribution of retardation vectors, is determined in each case for a light bundle emerging from a selected field point, it is possible to determine the total retardation of a complex optical system in its exit pupil by superposition of the retardation distributions which have been obtained in the aforementioned way for each individual lens. If the optical system does not contain any imaging mirrors or intermediate images, then the retardation distribution in the exit pupil is obtained straightforwardly as the sum of the retardation distributions of the individual lenses. If, furthermore, only the vector modes V₁, V₃ and V₆ occur in all lenses in question, as is often the case, then the superposition coefficients for the entire optical system are obtained as the sum of the individual coefficients according to

$${v}_{1}^{tot} = {\sum }_{all lenses} {v}_{1}^{lens i} \\ {v}_{3}^{tot} = {\sum }_{all lenses} {v}_{3}^{lens i} \\ {v}_{6}^{tot} = {\sum }_{all lenses} {v}_{6}^{lens i} \qquad ( 27 )$$

If the optical system contains intermediate image planes, then a kind of inversion of the regions 32 takes place. This can be taken into account by inverting the retardation distributions by point reflection after an intermediate image plane.

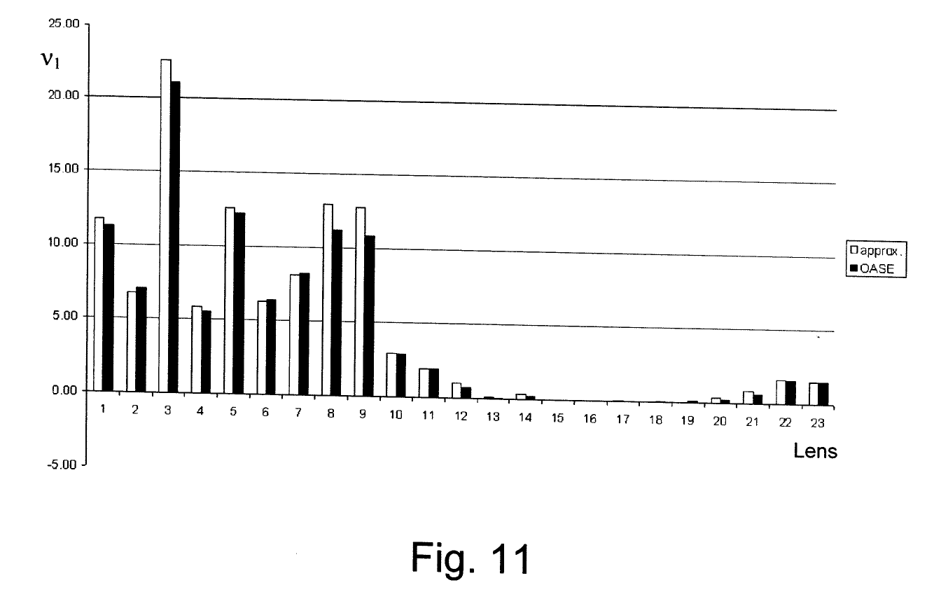

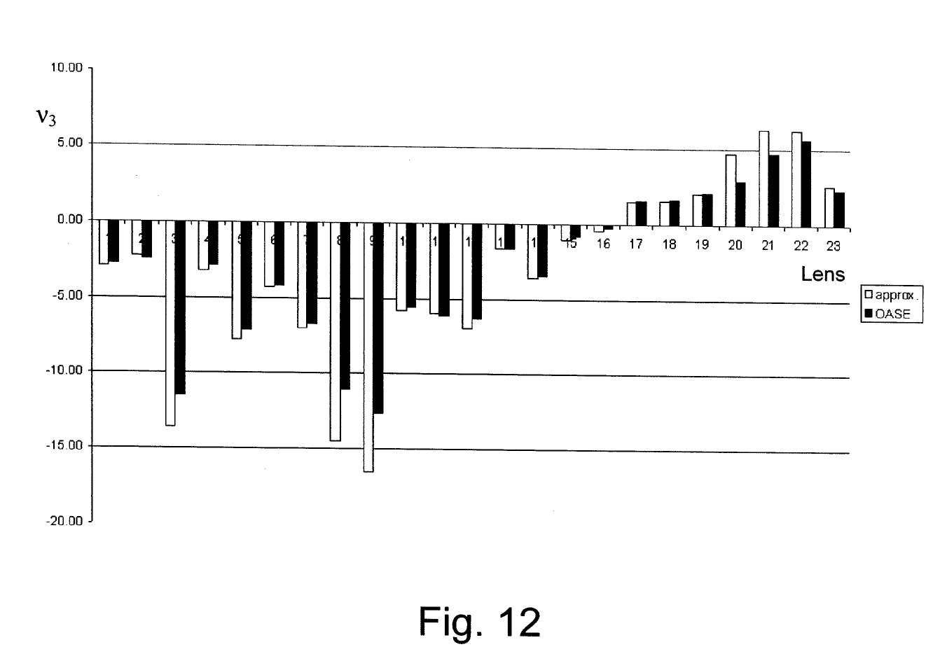

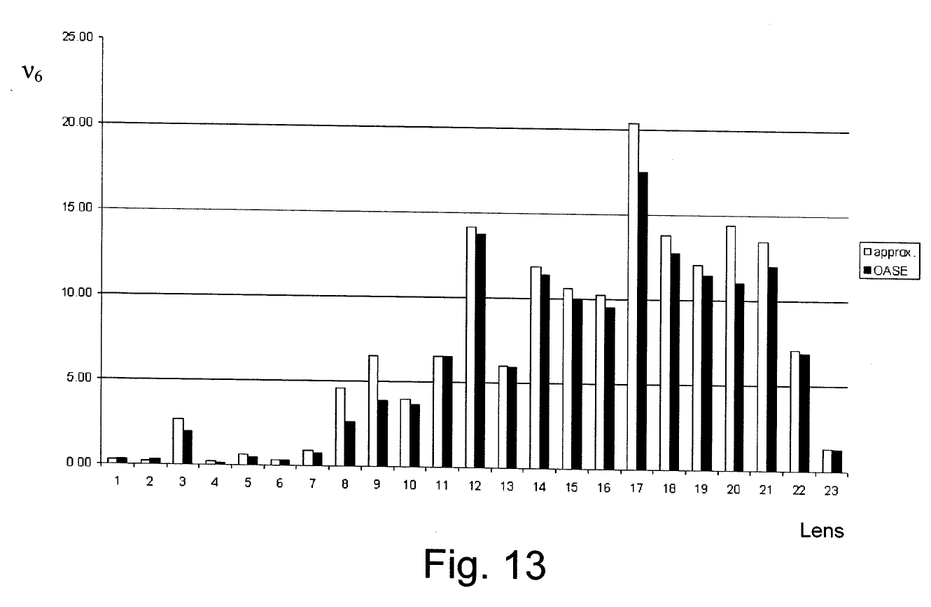

FIGS. 11 to 13 show the superposition coefficients v₁, v₃ and v₆ in the form of bar charts for a hypothetical projection objective with 23 lenses in all. The values indicated by white bars were in this case determined by the aforementioned approximation method. The values indicated by black bars were determined by the method described further above, in which the path through the entire projection objective was calculated exactly from multiplicity of light rays.

The projection objective on which this is based contains neither mirrors nor intermediate image planes, and has a numerical aperture NA=0.85. The lenses of the projection objective, which is designed for a wavelength of 193 nm, are all made from quartz glass preforms which have a rotationally symmetrical stress-induced birefringence. It is furthermore assumed that the value of the stress-induced birefringence increases quadratically and reaches 10 nm/cm at the edge. An off-axial field point with the coordinates x=13 mm and y=0 mm was furthermore considered.

FIGS. 11 to 13 show that the superposition coefficients v₁, v₃ and v₆ determined by the approximation method only differ relatively slightly from the exact values. The greatest deviations are found in lenses with very curved surfaces or in lenses through which the beam paths extend with large convergence or divergence.

As mentioned above, the superposition coefficients v₁, v₃ and v₆ express the values of a constant part, a tilt and a quadratic rotationally symmetrical part of the retardation distribution in the exit pupil. Information about particular imaging properties of the projection objective 20 can be derived directly from these components.

A retardation with constant magnitude and orientation, which is described by the vector mode V₁, causes a change of the polarization state in the exit pupil for linearly polarized light so long as the polarization direction of the light is not by chance parallel or perpendicular to the direction of the retardation. Such a change of the polarization state degrades the imaging properties and therefore should not exceed a particular tolerable value. If the illumination device 12 produces an unpolarized projection light beam 13, then a constant retardation effectively has no impact on the image formed on the wafer W.

A tilt in the retardation distribution, as described by the vector mode V₃, causes a transverse shift of the image for linearly polarized illumination. For unpolarized illumination, two sub-images with opposite transverse shifts are superimposed, which leads to a contrast loss.

For linearly polarized illumination, a quadratic rotationally symmetrical retardation as described by the vector mode V₆ causes an astigmatism in the exit pupil, the sign of which changes when the polarization direction is rotated through 90°. For unpolarized illumination, two sub-images with opposite astigmatism are superimposed. For a particular structure orientation, this means that two sub-images mutually shifted in the direction of the optical axis are superimposed. This also causes a contrast loss.

A combination of tilt and quadratic rotationally symmetrical retardation causes a telecentric error.

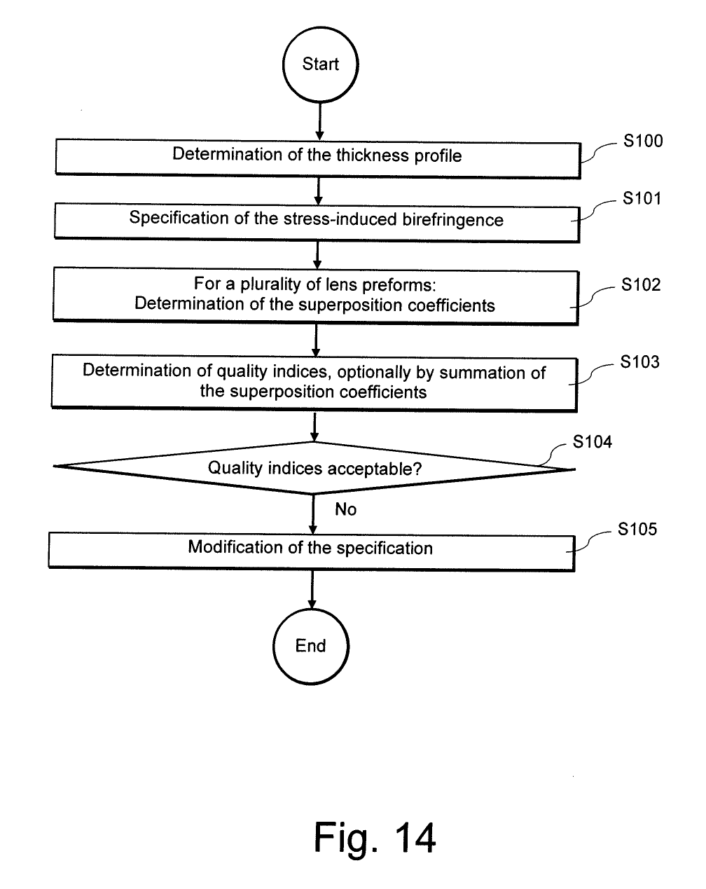

The method represented with reference to a flow chart in FIG. 14 may be employed in order to reduce the aforementioned undesirable effects of the retardation:

First, the thickness profile of the lenses of the optical system is determined in a step S100. The thickness profile of the lenses is obtained directly from the design data of the optical system. Provisional specifications of the stress-induced birefringence are then firstly established in a step S101 for the lenses of the optical system. In a further step S102, the superposition coefficients vᵢ are determined for some or all of the lens preforms, as explained above with reference to the flow chart shown in FIG. 8.

Quality indices are determined in a step S103 from the superposition coefficients of the same order. In the simplest case, that is to say for optical systems without intermediate images or mirrors, the quality indices are obtained by summation of the superposition coefficients of the lens preforms according to Equation (27).

If it is established in a step S104 that the quality indices determined in this way lie outside a tolerable range, then the specifications for the stress-induced birefringence are changed in a step S105.

Such a modification can be carried out according to two approaches. First, a check may be made as to whether compensation for the retardation can be offered by a birefringence distribution which is orthogonal to the originally selected orientation. As shown in FIGS. 11 to 13, the superposition coefficients may take both positive and negative values. A favorable combination of lens preforms with radially or tangentially oriented fast birefringent axes therefore provides the opportunity to reduce the retardation by mutual compensation.

For lenses in which particularly large superposition coefficients occur, another way is to tighten the specifications so that a only lower stress-induced birefringence is now permissible. This may be affected by questions regarding the availability and costs of such preforms.

The exemplary embodiments described above concentrated on the projection objective 20 of the projection exposure apparatus 10. In the scope of the present invention, it is of course also possible for the retardation distribution in the illumination device 12 to be described and optionally corrected in a similar way. The illumination device 12 also has an exit pupil, in which a total retardation distribution is defined. If need be, the description and correction may also be carried out only for a subcomponent of the illumination device 12. The objective 19, which projects a sharp image of the diaphragm 18 onto the object plane 22, is particularly relevant in this context.

The above description of the preferred embodiments has been given by way of example. From the disclosure given, those skilled in the art will not only understand the present invention and its attendant advantages, but will also find apparent various changes and modifications to the structures and methods disclosed. The applicant seeks, therefore, to cover all such changes and modifications as fall within the spirit and scope of the invention, as defined by the appended claims, and equivalents thereof.

1.-45. (canceled)

46. An optical system of a microlithographic projection exposure apparatus, comprising:
a) a first lens which has a rotationally symmetrical birefringence distribution induced by material stresses, with a tangentially extending slow birefringent axis, and
b) a second lens which has a rotationally symmetrical birefringence distribution induced by material stresses, with a radially extending slow birefringent axis, wherein the magnitude of the birefringence respectively increases at least approximately quadratically as the distance from the symmetry axes of the lenses increases.

47.-50. (canceled)
